(19) United States
(12) Patent Application Publication
(10) Pub. No.: US 2009/0107463 A1
(43) Pub. Date: Apr. 30, 2009

(54) FUEL INJECTION VALVE

(75) Inventor: Kazufumi SERIZAWA, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/202,475

(22) Filed: Sep. 2, 2008

(30) Foreign Application Priority Data
Oct. 24, 2007 (JP) 2007-276836

(51) Int. Cl. F02M 51/00

(52) U.S. Cl. 123/476

(57) ABSTRACT

A valve element is movable in a main body for opening and closing the nozzle hole. A pressure control chamber is formed at an end of the valve element and configured to receive high-pressure fuel to bias the valve element so as to close a nozzle hole. A first communication passage communicates the pressure control chamber with a low pressure side. An accommodating chamber is located downstream of the first communication passage and acommodates a valve member. A low-pressure opening is for exhausting fuel from the accommodating chamber. The valve member has a valve portion to control fuel flowing from the pressure control chamber to the low pressure side. The accommodating chamber and the low-pressure opening therebetween has a passage, which defines a throttle portion.

### CROSS REFERENCE TO RELATED APPLICATIONS

This application is based on and incorporates herein by reference Japanese Patent Application No. 2007-276836 filed on Oct. 24, 2007.

### FIELD OF THE INVENTION

The present invention relates to a fuel injection valve for an internal combustion engine.

### BACKGROUND OF THE INVENTION

For example, according to a fuel injection valve disclosed in U.S. Pat. No. 5,671,715 (JP-A-8-319917)), a control valve is provided to adjust fuel pressure in a pressure control chamber so as to control a biasing force exerted on a valve element in a valve-closing direction, and thereby controlling an opening and closing operation of the valve element. In the present fuel injection valve, the control valve has a solenoid portion and a valve body. The valve body is opened to discharge fuel from the pressure control chamber to a low-pressure side through a throttle portion, thereby reducing the fuel pressure in the pressure control chamber. In consequence, the biasing force exerting on the valve element is reduced to open the valve element. In recent years, it is required to reduce emission such as nitrogen oxide (NOx), particulate matter (PM), carbon dioxide (CO2), and the like, because of tightening of regulations of emission of automobiles. To meet such a requirement, a fuel injection valve is required to reduce variation in fuel injection quantity.

The fuel injection valve disclosed in U.S. Pat. No. 5,671,715 is, however, configured so that fuel discharged from a throttle portion is exhausted outside of the fuel injection valve through a low-pressure opening after passing through an accommodating chamber in which the valve body is accommodated for opening and closing the throttle portion. The accommodating chamber is in communication with the pressure control chamber through the throttle portion. The pressure control chamber is configured to receive relatively high pressure from fuel. On the other hand, the accommodating chamber is communicated with the low,pressure opening, and therefore the accommodating chamber is filled with relatively low-pressure fuel.

Caused by opening and closing the throttle portion with the valve body for each time of injecting the fuel, the inflow or the stop of the inflow of the high-pressure fuel from the pressure control chamber into the accommodating chamber is performed. Therefore, the pressure in the accommodating chamber significantly fluctuates to cause pressure pulsation. When the pressure fluctuation is caused in the accommodating chamber, the opening and closing operation of the valve body accommodated in the accommodating chamber is made unstable, leading to instability of the pressure control in the pressure control chamber. The instability of the pressure control in the pressure control chamber causes the opening and closing operation of the valve element to be unstable, and consequently increasing a variation in fuel injection quantity.

### SUMMARY OF THE INVENTION

The present invention is made in view of the foregoing and other problems and an object of the present invention is to provide a fuel injection valve capable of restricting a variation in fuel injection quantity.

According to one aspect of the present invention, a fuel injection valve for injecting fuel into a combustion chamber of an internal combustion engine, the fuel injection valve comprises a valve element. The fuel injection valve further comprises a main part having a nozzle hole and accommodating the valve element, which is movable for opening and closing the nozzle hole. The main part further has a pressure control chamber, which is formed at an end of the valve element on an opposite side of the nozzle hole and configured to receive fuel at high pressure to bias the valve element in a valve-closing direction to close the nozzle hole, a first communication passage, which is for communicating the pressure control chamber with a low-pressure side, an accommodating chamber, which is located downstream of the first communication passage, and a low-pressure opening, which is for discharging the fuel from the accommodating chamber to an outside of the main part. The fuel injection valve further comprises a valve member accommodated in the accommodating chamber and having an end provided with a valve portion for opening and closing the first communication passage to control discharge of the high-pressure fuel from the pressure control chamber to the low-pressure side. The fuel injection valve further comprises a solenoid configured to generate an electromagnetic force for actuating the valve member. The accommodating chamber and the low-pressure opening therebetween has a passage, which therein defines a throttle portion.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross sectional view showing a fuel injection valve according to a first embodiment of the present invention;

FIG. 2 is an enlarged cross sectional view showing a part of the fuel injection valve according to FIG. 1;

FIG. 3 is an enlarged cross sectional view showing a part of a fuel injection valve according to a second embodiment of the present invention;

FIG. 4 is an enlarged cross sectional view showing a part of a fuel injection valve according to a third embodiment of the present invention;

FIG. 5 is an enlarged cross sectional view showing a part of a fuel injection valve according to a fourth embodiment of the present invention; and

FIG. 6 is an enlarged cross sectional view showing a part of a fuel injection valve according to a fifth embodiment of the present invention.

### DETAILED DESCRIPTION OF PREFERRED EMBODIMENTS

### First Embodiment

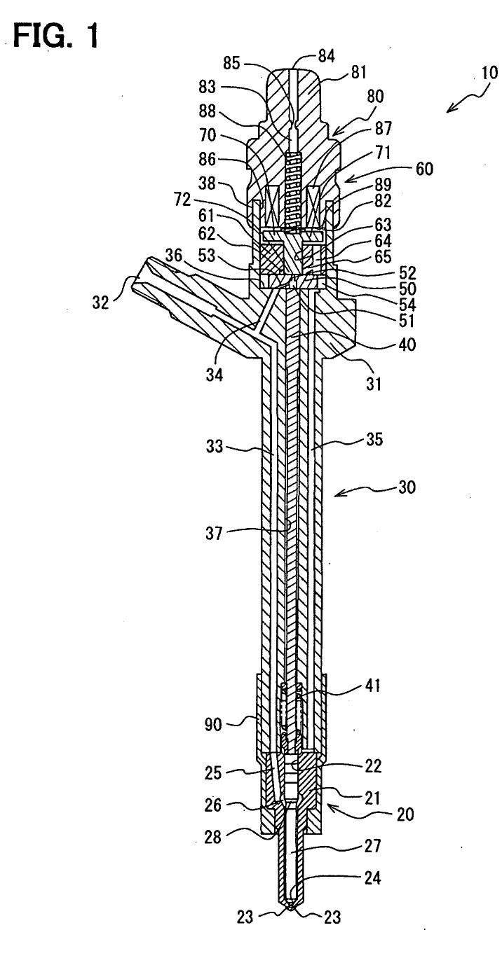

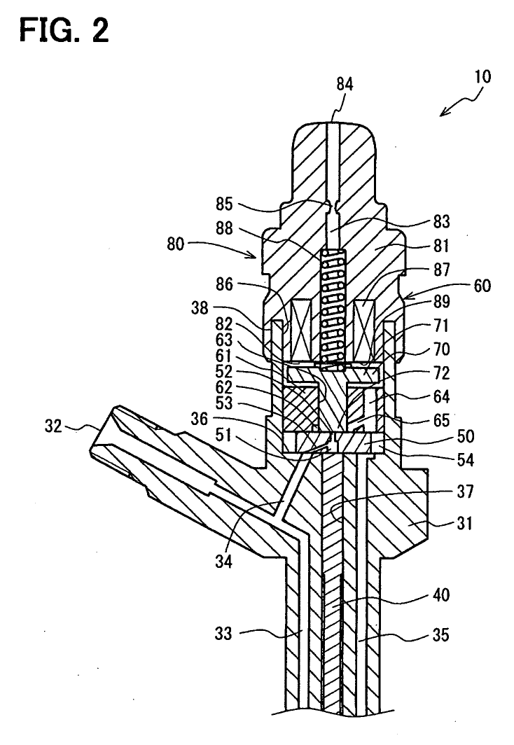

FIGS. 1 and 2 each shows a fuel injection valve 10 in use for a common rail fuel injection device for a diesel engine. The fuel injection valve 10 is mounted in a cylinder head of an engine (not shown) to directly inject high-pressure fuel, which is supplied from a common rail (not shown) for accumulating the high-pressure fuel, into each cylinder.

The fuel injection valve 10 includes a nozzle portion 20, a nozzle holder portion 30, a pressure control portion 60, and the like. The nozzle portion 20 and the nozzle holder portion 30 are jointed by a retaining nut 90. The nozzle holder portion 30 is joined with the pressure control portion 60 by fastening a male screw portion 38 formed in the nozzle holder portion 30 to a female screw portion 86 formed in the pressure control portion 60.

The nozzle portion 20 includes a nozzle body 21 and a needle 27. The nozzle body 21 is in a rod shape and provided with a needle accommodating bore 22 therein so as to extend in an axial direction. Nozzle holes 23 are formed in a tip end of the needle accommodating bore 22 for communicating an inner wall of the nozzle body 21 with an outer wall of the nozzle body 21. A valve seat 24, on which the needle 27 is seated, is formed upstream of the nozzle holes 23 in the nozzle body 21.

The nozzle body 21 has a fuel supply passage 25 therein to be connected to a side portion of the needle accommodating bore 22. The fuel supply passage 25 supplies high-pressure fuel to the needle accommodating bore 22.

The needle 27 is in a rod shape and accommodated in the needle accommodating bore 22. As the needle 27 is accommodated in the needle accommodating bore 22, the outer wall of the needle 27 and the inner wall of the nozzle body 21 therebetween define a fuel reservoir chamber 26. The fuel reservoir chamber 26 is communicated with the fuel supply passage 25 and the nozzle holes 23. The needle 27 has a pressure-receiving portion 28. When the fuel is supplied to the fuel reservoir chamber 26, the fuel pressure exerts on the pressure-receiving portion 28. Then, the needle 27 is subject to an upward force in a valve-opening direction.

When the needle 27 is seated on the valve seat 24, the communication between the fuel reservoir chamber 26 and the nozzle holes 23 is blocked. Therefore, even when the high-pressure fuel is supplied to the fuel reservoir chamber 26, the fuel is not injected from the nozzle holes 23. When the needle 27 is lifted from the valve seat 24, the fuel reservoir chamber 26 is communicated with the nozzle holes 23 and hence, the fuel is injected from the nozzle holes 23.

The nozzle holder portion 30 has one end supporting the nozzle portion 20 and the other end supporting the pressure control portion 60. The nozzle holder portion 30 includes a lower body 31, a command piston 40, a coil spring 41, an orifice plate 50, and the like.

The lower body 31 is in a rod shape and supports the nozzle body 21 at a lower end of the lower body 31. The lower body 31 has a high-pressure opening 32 connected to a fuel pipe extending from the common rail. A filter member (not shown) is attached to the high-pressure opening 32 for restricting foreign matter from entering into the fuel injection valve 10. The lower body 31 has a fuel supply passage 33 therein for supplying the high-pressure fuel from the high-pressure opening 32 to the fuel supply passage 25.

A recessed portion 36 recessed downward is formed at an upper end of the lower body 31. The lower body 31 therein has a branch passage 34 branching from the fuel supply passage 33. The branch passage 34 is opened to a bottom portion of the recessed portion 36. The lower body 31 therein has a piston accommodating bore 37 along the center axis. An end of the piston accommodating bore 37 at the side of the recessed portion 36 is opened to the bottom portion of the recessed portion 36, and an end of the piston accommodating bore 37 at the side of the nozzle portion 20 is opened to an end surface of the nozzle body 21. The piston accommodating bore 37 is communicated with the needle accommodating bore 22. The command piston 40 in a rod shape is accommodated in the piston accommodating bore 37 so as to be reciprocally movable therein.

The coil spring 41 is provided to an end of the piston accommodating bore 37 at the side of the nozzle portion 20. The coil spring 41 has an upper end supported on an inner wall of the lower body 31 at the side of the piston accommodating bore 37. The coil spring 41 has a lower end supported on an upper end surface of the needle 27. The coil spring 41 urges the needle 27 in the valve-closing direction. A leak passage 35 is formed in the lower body 31 for communicating a clearance, which is formed between the inner wall of the lower body 31 at the side of the piston accommodating bore 37 and the command piston 40, with the recessed portion 36.

As shown in FIG. 2, the orifice plate 50 is substantially in a disc shape and provided on the bottom portion of the recessed portion 36 in such a manner as to cover the piston accommodating bore 37. A pressure control chamber 51 is formed in an end surface of the orifice plate 50 at the bottom side of the recessed portion 36 to communicate with the piston accommodating bore 37. The orifice plate 50 has an outer orifice 52 therein for communication of the pressure control chamber 51 with an end surface of the orifice plate 50 at the opposite side of the recessed portion 36. The orifice plate 50 has an inner orifice 53 for communication of the branch passage 34 with the pressure control chamber 51. The outer orifice 52 has the passage diameter larger than that of the inner orifice 53. The outer orifice 52 is equivalent to a first communication passage.

The high-pressure fuel is supplied to the pressure control chamber 51 through the branch passage 34. The pressure of the high-pressure fuel supplied to the pressure control chamber 51 exerts on an upper end surface of the command piston 40. In consequence, a force for pressing the needle 27 downward, that is, in the valve-closing direction exerts on the command piston 40. In the present embodiment, the needle 27 and the command piston 40 are equivalent to a valve element.

Since an outer diameter of the orifice plate 50 is smaller than an inner diameter of the recessed portion 36, a fuel passage 54 is formed between the outer wall of the orifice plate 50 and the inner wall of the recessed portion 36. The fuel passage 54 is communicated with the leak passage 35.

As shown in FIG. 2, the pressure control portion 60 includes a valve body 61, a valve member 70, a solenoid 80, and like. The valve body 61 is substantially in a columnar shape and provided to the orifice plate 50 at the side of the outer orifice 52. The valve body 61 has an accommodating chamber 62 therein. A vertical groove 63 is formed above the accommodating chamber 62. The valve body 61 therein has a fuel passage 64 penetrating an end surface of the valve body 61 at the side of the orifice plate 50 and an end surface of the valve body 61 at the opposite side of the orifice plate 50. The fuel passage 64 is communicated with the fuel passage 54. The valve body 61 has a communication passage 65 therein for communication of the fuel passage 64 with the accommodating chamber 62.

The valve member 70 includes an armature 71 and a valve portion 72. The armature 71 is equivalent to a main portion, and the valve portion 72 is equivalent to a valve portion. The armature 71 includes a substantially disc-shaped disc portion and a columnar portion. The disc portion and the orifice plate 50 are located at the opposite sides of the valve body 61. The columnar portion is supported by the vertical groove 63 so as to be reciprocally movable therein. The valve portion 72 is provided in a tip end of the columnar portion of the armature 71. The valve portion 72 opens and closes the outer orifice 52 according to a reciprocal movement of the armature 71.

When the valve portion 72 opens the outer orifice 52, the high-pressure fuel is discharged from the pressure control chamber 51 to the accommodating chamber 62 at the low pressure side, thereby reducing the fuel pressure in the pressure control chamber 51. The fuel discharged to the accommodating chamber 62 flows into the fuel passage 64 through the communication passage 65.

The solenoid 80 includes a stator 81, a coil 87, a coil spring 88, and the like. The stator 81 is substantially in a columnar shape. The stator 81 and the orifice plate 50 are located at the opposite sides of the valve body 61. An armature chamber 82 is formed between the stator 81 and the valve body 61 for accommodating the armature 71 in such a manner as to be reciprocally movable therein. The stator 81 has the female screw portion 86 thereon. The female screw portion 86 is engaged to the male screw portion 38 formed in the recessed portion 36. The armature chamber 82 is communicated with the fuel passage 64 of the valve body 61.

The stator 81 has a low-pressure passage 83 formed along the center axis. A low-pressure opening 84 is formed in an end of the low-pressure passage 83. The coil spring 88 is provided to an end of the low-pressure passage 83 at the side of the armature 71. Fuel flows into the armature chamber 82 through the fuel passage 64 of the valve body 61, and the fuel passes the low-pressure passage 83, and subsequently the fuel is discharged from the low-pressure opening 84 to the outside of the fuel injection valve 10.

The low-pressure passage 83 is provided with an orifice 85 therein. The orifice 85 has the passage diameter smaller than the passage diameter of the low-pressure passage 83. An effect produced by providing the orifice 85 will in detail described later.

The coil 87 is provided at the outer periphery of the low-pressure passage 83. The coil 87 receives electric power from an external power source (not shown). When the coil 87 is energized, magnetic flux is generated to pass through the stator 81 and the armature 71, and the magnetic attraction force acts between an attraction portion 89 and the armature 71. Thus, the armature 71 and the valve portion 72 move in the valve-opening direction.

Next, an operation of the fuel injection valve 10 is described with reference to FIGS. 1, 2. High-pressure fuel pressurized by a fuel injection pump (not shown) is supplied to the fuel supply passage 33 through a pipe connected to the high-pressure opening 32. The high-pressure fuel supplied to the fuel supply passage 33 flows into the fuel reservoir chamber 26 through the fuel supply passage 25 and also flows into the pressure control chamber 51 through the branch passage 34 and the inner orifice 53.

In a state where the coil 87 is not energized, the valve portion 72 closes the outer orifice 52 by being applied with the biasing force of the coil spring 88. In the present state, the high-pressure fuel flowing into the pressure control chamber 51 is accumulated in the pressure control chamber 51 without being discharge to the low pressure side.

A force in the valve-opening direction exerts on the needle 27 by being applied with the fuel pressure of the high-pressure fuel in the fuel reservoir chamber 26 thereon. However, a sum of the force of pressing downward the needle 27 in the valve-closing direction from the command piston 40, which is applied with the fuel pressure of the high-pressure fuel in the pressure control chamber 51, and the coil spring 41 is larger than the upward force exerted in the valve-opening direction. Thus, in the present state, the needle 27 maintains the valve-closing state. Therefore, the communication between the fuel reservoir chamber 26 and the nozzle holes 23 is blocked and the fuel is not injected.

When the coil 87 is energized by a control device (not shown), the magnetic attraction force is generated between the attraction portion 89 of the stator 81 and the armature 71. Thus, the armature 71 is attracted to the attraction portion 89, and in consequence, the valve portion 72 opens the outer orifice 52. Then, the high-pressure fuel is discharged from the pressure control chamber 51 through the outer orifice 52. Since the outer orifice 52 has the passage diameter larger than the passage diameter of the inner orifice 53, the fuel pressure in the pressure control chamber 51 is lowered.

The fuel discharged from the pressure control chamber 51 once flows into the accommodating chamber 62. The fuel flowing into the accommodating chamber 62 passes through the communication passage 65, the fuel passage 64, the armature chamber 82, the low-pressure passage 83, and the low-pressure opening 84. Thus, the fuel is discharged to, for example, a low pressure component such as a fuel tank through a pipe connected to the low-pressure opening 84.

When the fuel pressure in the pressure control chamber 51 is lowered, the force acting on the command piston 40 to press the needle 27 in the valve-closing direction is reduced. In the present operation, the force acting on the needle 27 to upward press the needle 27 in the valve-opening direction is larger than the force pressing the needle 27 in the valve-closing direction. Thus, the needle 27 moves in the valve-opening direction. In consequence, the fuel reservoir chamber 26 is communicated with the nozzle holes 23, and the fuel is injected from the nozzle holes 23.

Next, one of features of the present embodiment is described with reference to FIG. 2. According to the present embodiment, the orifice 85 is provided between the accommodating chamber 62 and the low-pressure opening 84. More specially, the orifice 85 is provided in the low-pressure passage 83 formed in the stator 81.

In the fuel injection valve. 10 according to the present embodiment, the high-pressure fuel at several hundreds of megapascals is supplied to the high-pressure opening 32. In a state where the valve portion 72 closes the outer orifice 52, the downstream side of the outer orifice 52 is regularly communicated with a low-pressure side (low-pressure component). Therefore, the fuel pressure downstream of the outer orifice 52 is at several tens of kilopascals, for example.

When the valve portion 72 opens the outer orifice 52 for fuel injection, the fuel at a relatively high pressure such as several tens of megapascals to several hundreds of megapascals flows from the pressure control chamber 51 into the accommodating chamber 62. When the valve portion 72 again closes the outer orifice 52, the fuel pressure in the accommodating chamber 62 returns back to several tens of kilopascals. Repetition of fuel injection and injection stop causes the fuel pressure in the accommodating chamber 62 to significantly fluctuate, thus generating pressure pulsation.

Since the valve portion 72 is arranged to operate in such a condition, the valve portion 72 may be unstable in operation due to the fluctuation in pressure and pulsation. In contrast, according to the present embodiment, the orifice 85 is provided in the low-pressure passage 83 for restricting outflow of the fuel. The present structure is configured to restrict the outflow of fuel and therefore restrict reduction in the fuel pressure in the accommodating chamber 62 due to outflow of fuel to the low pressure side in the duration where the valve portion 72 closes the outer orifice 52.

Therefore, when the valve portion 72 opens the outer orifice 52 to exert the fuel pressure to the accommodating chamber 62 at the next time, the difference in pressure between the exerted fuel pressure and the remaining fuel pressure in the accommodating chamber 62 can be made small. The present small difference in pressure can restrict the pressure fluctuation in the accommodating chamber 62 to be small and also can restrict the pressure pulsation to be small.

In consequence, the influence of the pressure pulsation, which the valve portion 72 is subject to, can be restricted to be small as well. Therefore, the operation of the valve portion 72 can be made stable, and also adjustment of the pressure in the pressure control chamber 51 can be made stable, so that the operation of the needle 27 is made stable. In consequence, variations in quantity of fuel injected from the nozzle holes 23 can be reduced.

In the present embodiment, the low-pressure passage 83 is formed in the stator 81, and therefore, the present embodiment can be applied to a fuel injection valve having a structure in which fuel is discharged from the top of the fuel injection valve. Further, in the present embodiment, the orifice 85 is formed in the low-pressure passage 83. The stator 81 is generally made from a material lower having hardness lower than that of the lower body 31. Thus, the orifice 85 can be easily manufactured.

### Second Embodiment

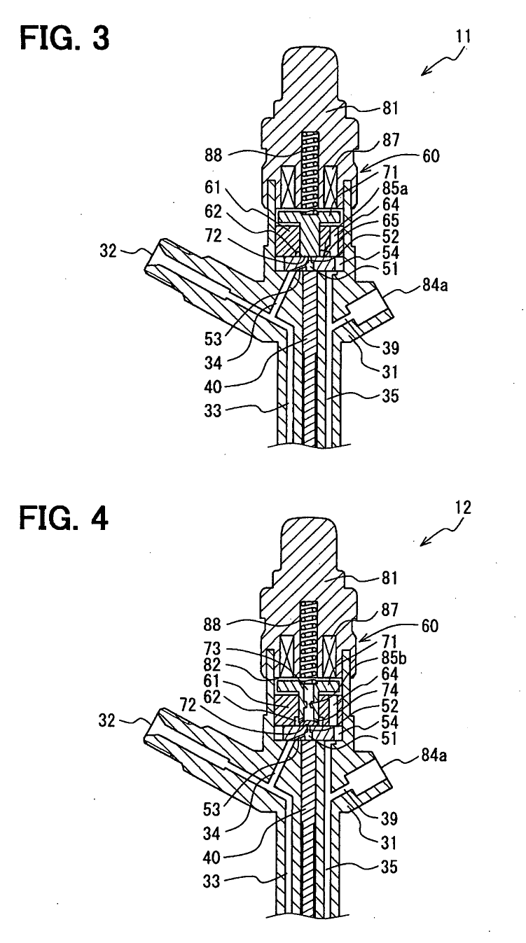

As shown in FIG. 3, in the present second embodiment, an orifice 85a is provided in a fuel injection valve 11, in which a low-pressure opening 84a is formed in the lower body 31 dissimilarly to the first embodiment. The orifice 85a corresponds to the orifice 85 in the first embodiment.

As shown in FIG. 3, the lower body 31 has the low-pressure opening 84a therein to be connected to a pipe in communication with a fuel tank or the like. The lower body 31 therein has a low-pressure branch passage 39, which is branched from the leak passage 35 and communicated with the low-pressure opening 84a. Further, the orifice 85a is formed in the communication passage 65 of the valve body 61.

When the valve portion 72 opens the outer orifice 52, the high-pressure fuel in the pressure control chamber 51 once flows into the accommodating chamber 62. Thereafter, the fuel passes through the communication passage 65 and flows into the fuel passage 64. The fuel flowing into the fuel passage 64 is discharged from the low-pressure opening 84a to the outside through the fuel passage 54, the leak passage 35, and the low-pressure branch passage 39.

In the present embodiment, the orifice 85a is also formed between the accommodating chamber 62 and the low-pressure opening 84a, and therefore pressure pulsation in the accommodating chamber 62 can be restricted to be small.

### Third Embodiment

As shown in FIG. 4, in the present third embodiment, an orifice 85b is provided in a fuel injection valve 12, in which the low-pressure opening 84a is formed in the lower body 31, as in the case of the second embodiment. The orifice 85b corresponds to the orifice 85 in the first embodiment.

As shown in FIG. 4, the lower body 31 has the low-pressure opening 84a therein to be connected to the pipe in communication with the fuel tank or the like. The lower body 31 therein has the low-pressure branch passage 39, which is branched from the leak passage 35 and communicated with the low-pressure opening 84a.

The armature 71 therein has a communication passage 73 extending through the disc portion and the columnar portion. The valve portion 72 is provided to an end of the communication passage 73 at the side of the columnar portion axially to close the communication passage 73. The columnar portion has a through bore 74 therein so as to communicate the communication passage 73 with the side wall of the columnar portion. The communication passage 73 has the orifice 85b therein. According to the present structure, the communication passage 65, which is described in the first embodiment and for communicating the fuel passage 64 with the accommodating chamber 62, need not be formed in the valve body 61. Therefore, the structure of the valve body 61 can be simplified.

When the valve portion 72 opens the outer orifice 52, the high-pressure fuel in the pressure control chamber 51 once flows into the accommodating chamber 62. Thereafter, the fuel passes through the communication passage 73 and the through bore 74 and flows into the armature chamber 82. The fuel flowing into the armature chamber 82 is discharged from the low-pressure opening 84a to the outside after passing through the fuel passage 64, the fuel passage 54, the leak passage 35, and the low-pressure branch passage 39.

In the present embodiment, the orifice 85b is also formed between the accommodating chamber 62 and the low-pressure opening 84a, and therefore pressure pulsation in the accommodating chamber 62 can be restricted to be small.

### Fourth Embodiment

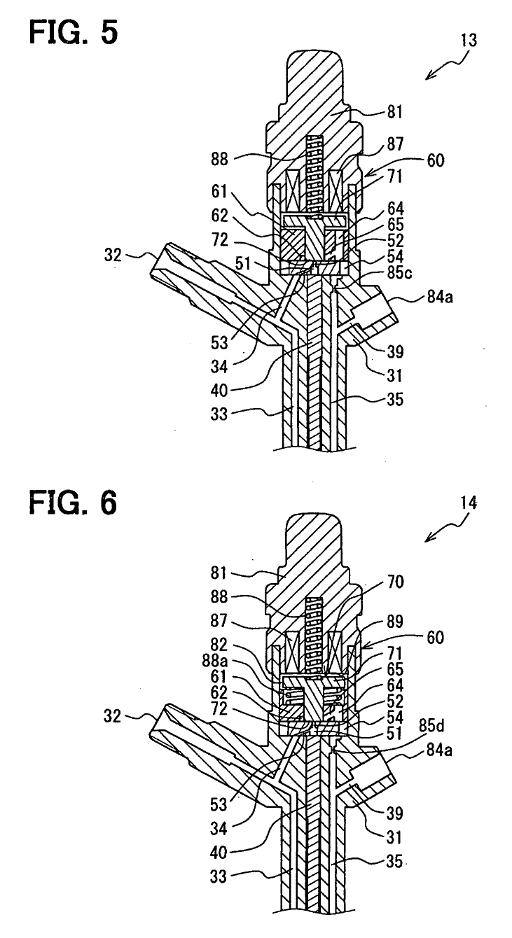

As shown in FIG. 5, in the present fourth embodiment, the orifice 85b is provided in a fuel injection valve 13 in which the low-pressure opening 84a is formed in the lower body 31. An orifice 85c corresponds to the orifice 85 in the first embodiment.

As shown in FIG. 5, the lower body 31 has the low-pressure opening 84a therein to be connected to the pipe in communication with the fuel tank or the like. The lower body 31 therein has the low-pressure branch passage 39, which is branched from the leak passage 35 and communicated with the low-pressure opening 84a.

The present embodiment does not have the orifice 85, 85a, or 85b, which is formed in each case of the first to third embodiments, but has the orifice 85c formed in the leak passage 35 of the lower body 31. More specially, the orifice 85c is formed in a portion of the leak passage 35. The portion of the leak passage 35 is closer to the pressure control portion 60 than the branch portion between the leak passage 35 and the low-pressure branch passage 39.

It should be noted that the portion of the leak passage 35, which is closer to the nozzle portion 20 than the branch portion, is equivalent to a first leak passage, and another portion of the leak passage 35, which is closer to the pressure control portion 60 than the branch portion, is equivalent to a second leak passage.

In the present embodiment, the orifice 85c is also formed between the accommodating chamber 62 and the low-pressure opening 84a, and therefore pressure pulsation in the accommodating chamber 62 can be restricted to be small.

### Fifth Embodiment

As shown in FIG. 6, in the present fifth embodiment, an orifice 85d is provided in a fuel injection valve 14 in which the low-pressure opening 84a is formed in the lower body 31, as in the cases of the second, third, and fourth embodiments. The orifice 85d corresponds to the orifice 85 in the first embodiment. The orifice 85d is formed substantially in the same location as in the orifice 85c in the fourth embodiment.

As shown in FIG. 6, in the present embodiment, a coil spring 88a is accommodated in the armature chamber 82 for biasing the armature 71 in the valve-opening direction. The biasing force of the coil spring 88a is smaller than the biasing force of the coil spring 88, which is described in the first embodiment and for biasing the armature 71 in the valve-closing direction. The coil spring 88 is equivalent to a first biasing unit and the coil spring 88a is equivalent to a second biasing unit.

When the coil 87 is energized to attract the armature 71 toward the attraction portion 89, the armature 71 collides against the attraction portion 89, and the armature 71 is lifted from the attraction portion 89 due to the reaction of the collision. When the coil 87 is being energized, the magnetic suction force acts between the attraction portion 89 and the armature 71, and therefore the armature 71 is again attracted to the attraction portion 89. This phenomenon is repeated until the collision energy generated at collision of the armature 71 against the attraction portion 89 becomes smaller than the magnetic attraction force. Thus, the repletion of the phenomenon makes the valve portion 72 vibrate.

In the present embodiment, the coil spring 88a is provided so as to bias the armature 71 in the valve-opening direction, which corresponds to the direction of exerting the magnetic attraction force. Therefore, the reaction caused by the collision of the armature 71 against the attraction portion 89 can be restricted. Therefore, time needed for convergence of the vibration of the valve member 70 can be reduced as much as possible. In consequence, the operation of the valve portion 72 can be made further stable.

In the present embodiment, the coil spring 88a is applied to the fuel injection valve having the leak passage 35 provided with the orifice 85d. Alternatively, the coil spring 88a may be applied to each of the fuel injection valves 10, 11, and 12 shown in the first to third embodiments.

In the above embodiments, the throttle portion 85, 85a, 85b, 85c, 85d is configured to restrict reduction in pressure in the accommodating chamber 62 when the valve portion 72 opens the first communication passage 52 to communicate the pressure control chamber 51 with the low-pressure side. Therefore, the operation of the valve portion 72 is stabilized. The throttle portion 85, 85a, 85b, 85c, 85d is, for example, the orifice 85, 85a, 85b, 85c, 85d, which reduces a cross sectional area in the passage between the accommodating chamber 62 and the low-pressure opening 84. The orifice 85, 85a, 85b, 85c, 85d may be integrally formed with the passage between the accommodating chamber 62 and the low-pressure opening 84. The disc portion of the valve member 70 may be formed from a magnetic material and substantially in the disc-shape. The disc portion is configured to be attracted from the solenoid 80. The first communication passage 52 has the orifice configured to restrict pressure in the pressure control chamber 51 from exerted to the accommodating chamber 62 when the valve portion 72 opens the first communication passage 52.

The above embodiments may be arbitrary combined. For example, at least two of the orifices 85, 85a, 85b, 85c may be combined so as to conduct multistage pressure reduction from the high-pressure side to the low-pressure side in the fuel injection valve.

Various modifications and alternations may be diversely made to the above embodiments without departing from the spirit of the present invention.

What is claimed is:

1. A fuel injection valve for injecting fuel into a combustion chamber of an internal combustion engine, the fuel injection valve comprising:
a valve element;
a main part having a nozzle hole and accommodating the valve element, which is movable for opening and closing the nozzle hole, the main part further having a pressure control chamber, which is formed at an end of the valve element on an opposite side of the nozzle hole and configured to receive fuel at high pressure to bias the valve element in a valve-closing direction to close the nozzle hole, a first communication passage, which is for communicating the pressure control chamber with a low-pressure side, an accommodating chamber, which is located downstream of the first communication passage, and a low-pressure opening, which is for discharging the fuel from the accommodating chamber to an outside of the main part;
a valve member accommodated in the accommodating chamber and having an end provided with a valve portion for opening and closing the first communication passage to control discharge of the high-pressure fuel from the pressure control chamber to the low-pressure side; and
a solenoid configured to generate an electromagnetic force for actuating the valve member,
wherein the accommodating chamber and the low-pressure opening therebetween has a passage, which therein defines a throttle portion.

2. The fuel injection valve according to claim 1,
wherein the main part has one end defining the nozzle hole,
the main part has an other end provided with the solenoid,
the solenoid includes a coil and a stator,
the stator supports the coil and configured to attract the valve member,
the stator has a low-pressure passage, which has one end communicated with the accommodating chamber, and an other end communicated with low-pressure opening, and
the low-pressure passage has the throttle portion.

3. The fuel injection valve according to claim 1,
wherein the valve body is located between the solenoid and the first communication passage and configured to support the valve member so as to be movable in opening and closing directions,
the valve body defines the accommodating chamber,
the valve body has a second communication passage for communicating the accommodating chamber with the low-pressure opening, and
the second communication passage has the throttle portion.

4. The fuel injection valve according to claim 1,
wherein the valve member includes the valve portion and a main portion,
the main portion supports the valve portion,
the valve body is located between the solenoid and the first communication passage and configured to support the main portion so as to be movable in opening and closing directions,
the valve body defines the accommodating chamber,
the main portion has a third communication passage for communicating the accommodating chamber with the low-pressure opening, and
the third communication passage has the throttle portion.

5. The fuel injection valve according to claim 1,
wherein the main part has a first leak passage for leading fuel from a slide clearance between the valve element and the main part to the low-pressure opening,
the main part has a second leak passage for communicating the accommodating chamber with the first leak passage, and
the second leak passage has the throttle portion.

6. The fuel injection valve according to claim 1, further comprising:
a first biasing unit configured to exert first biasing force to bias the valve member in the valve-closing direction; and
a second biasing unit configured to exert second biasing force to bias the valve portion in the valve-opening direction,
wherein the second biasing force of second biasing unit is smaller than the first biasing force of the first biasing unit.

7. The fuel injection valve according to claim 1, wherein the throttle portion is configured to restrict reduction in pressure in the accommodating chamber when the valve portion opens the first communication passage to communicate the pressure control chamber with the low-pressure side.

8. The fuel injection valve according to claim 1, wherein the throttle portion is an orifice, which reduces a cross sectional area in the passage between the accommodating chamber and the low-pressure opening.

9. The fuel injection valve according to claim 8, wherein the orifice is integrally formed with the passage between the accommodating chamber and the low-pressure opening.

10. The fuel injection valve according to claim 1,
wherein the valve member includes the valve portion and a disc portion,
the disc portion is formed from a magnetic material and substantially in a disc-shape, and
the disc portion is configured to be attracted from the solenoid.

11. The fuel injection valve according to claim 1, wherein the first communication passage has an orifice configured to restrict pressure in the pressure control chamber from exerted to the accommodating chamber when the valve portion opens the first communication passage.
